(19) United States
(12) Patent Application Publication
(10) Pub. No.: US 2008/0155959 A1
(43) Pub. Date: Jul. 3, 2008

(54) DETONATION COMBUSTOR TO TURBINE TRANSITION PIECE FOR HYBRID ENGINE

(75) Inventors: Adam Rasheed, Glenville, NY (US); Anthony John Dean, Scotia, NY (US); James Fredric Wiedenhoefer, Clifton Park, NY (US); Venkat Eswarlu Tangirala, Niskayuna, NY (US); Narendra Digamber Joshi, Schenectady, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/963,212

(22) Filed: Dec. 21, 2007

Related U.S. Application Data
(60) Provisional application No. 60/876,880, filed on Dec. 22, 2006.
(60) Provisional application No. 60/988,171, filed on Nov. 15, 2007.

(51) Int. Cl. F02C 5/00; F01D 25/30; F02C 7/00

(52) U.S. Cl. 60/39.76; 415/220; 415/208.2

(57) ABSTRACT

A transition piece for use within a gas turbine engine provides a path between the exhaust from one or more pressure-rise combustors and a downstream turbine for the extraction of work from the exhaust flow. The transition piece provides a non-expanding path for the exhaust flow through the transition piece, and directs the flow so as to be effective in driving the turbine when it reaches the end of the transition piece.

### RELATED CASES

This case claims priority under 35 U.S.C. §119(e) to U.S. Provisional Patent Application Ser. No. 60/876,880 entitled “Detonation Combustor to Turbine Transition Piece for Hybrid Engines”, filed on 22 Dec. 2006, and to U.S. Provisional Patent Application Ser. No. 60/988,171 entitled “PULSE DETONATION COMBUSTOR/TURBINE HYBRID ENGINE CONFIGURATION”, filed on 15 Nov. 2007.

### BACKGROUND

The systems and techniques described herein related generally to a configuration for use in a gas turbine engine that makes use of a pressure-rise combustion system. More specifically, the systems and techniques relate to the configuration of the flow path between a pressure-rise combustor and a turbine stage of a gas turbine engine.

In a traditional gas turbine engine, an incoming body of air is compressed, fuel is added to the compressed air, the fuel/air mixture is ignited and burned in a combustor, and then the hot exhaust from the combustor is allowed to expand through a turbine and out the back of the engine. The operation of the engine produces thrust in the form of increased momentum of the exhaust flow compared to the incoming flow, as well as shaft power that may be produced from the flow through the turbine.

Many variations of this basic operation exist, some optimized to produce more thrust and little or no excess shaft power, some to produce low thrust but high shaft power. However, in every case, the energy output from the system, whether thrust or shaft power, is generated by the combustion of the fuel in the combustor.

In a traditional engine, the combustion that takes place is a form of essentially constant pressure combustion, i.e., the fuel/air mixture burns without a significant increase in the pressure of the products compared to the pressure of the reactants. However, combustion that produces a pressure rise can be effective in extracting more energy from the fuel, and therefore producing more efficient combustion.

Such combustors that operate in a pressure-rise mode are generally based on detonative or quasi-detonative forms of combustion. While much effort has gone into producing various forms of detonative combustor, particularly those that operate in a pulsed manner, much work still remains in incorporating a pulse detonation combustor into the overall system of a gas turbine engine. Specifically, continued development is needed in extracting energy from a pulse detonation combustor.

Typical operation of a pulse detonation combustor generates a very high speed, high pressure pulsed flow, as a result of the detonation process. These peaks are followed by periods of significantly lower speed and lower pressure flow. Because the operation of pulse detonation combustors and the detonation process is known, it will not be discussed in detail herein. When a pulse detonation combustor is used in the combustion stage of a gas turbine engine, the pulsed, highly transient flow is directed into the turbine stage (s).

Therefore, there exists a need to effectively and efficiently direct the exhaust from the pulse detonation combustor into the turbine stage in such a way as to allow effective engine operation.

### BRIEF DESCRIPTION

In accordance with one aspect of the systems and techniques described herein a transition piece for a gas turbine engine has a body, an exhaust face and turbine inlet face. The exhaust face is in flow communication with an exhaust of a pulse detonation combustor of the gas turbine engine. The body takes the flow from the PDC upstream of the exhaust face and conducts it to the turbine inlet face, the body being in flow communication with both the exhaust face and the turbine inlet face. The body has a cross section taken normal to the axis of the gas turbine engine such that the area of the cross section at any given point along the axis of the gas turbine engine is smaller than the area of the cross section of the body at any point along the axis of the gas turbine engine upstream of the given point. The turbine inlet face is in flow communication with a turbine stage of the gas turbine engine, the turbine stage being located downstream of the transition piece.

In accordance with another aspect of the systems and techniques described herein, a hybrid gas turbine engine having a transition piece as described above also includes a plurality of pulse detonation combustors disposed around an axis of the gas turbine engine.

In accordance with yet another aspect of the systems and techniques described herein, a hybrid gas turbine engine having a transition piece as described above also includes a turbine disposed downstream of the transition piece and in flow communication with the transition piece.

In accordance with a further aspect of the systems and techniques described herein, multiple transition pieces may be used within a single gas turbine engine.

In accordance with still another further aspect of the systems and techniques described herein, turning vanes may be disposed within the transition piece as described above.

### DRAWINGS

Features, aspects, and advantages of the present invention will become better understood when the following detailed description is read with reference to the accompanying drawings in which like characters represent like parts throughout the drawings, wherein:

FIG. 1 is a view along the axial direction of an exemplary transition piece, looking upstream;

FIG. 2 is a view of the transition piece of FIG. 1;

FIG. 3 is an exemplary configuration of three transition pieces such as those of FIG. 1 arranged around a central space;

FIG. 4 is a graph that illustrates the cross section of the exemplary transition piece of FIG. 1 at eight stations along its axial length, as well as a graph of the cross-sectional area along the length of the transition piece;

FIG. 5 illustrates an exemplary configuration of a system using transition pieces to redirect the flow between a set of PDCs and a turbine stage;

FIG. 6 illustrates another exemplary configuration of a system using transition piece between a set of PDCs with bypass flow and a turbine stage;

FIG. 7 illustrates schematically an exploded layout of a transition piece for use with multiple can-annular groupings of PDCs and a turbine;

FIG. 8 shows an axial view of an embodiment of a transition piece that has offset inlet and outlet faces;

FIG. 9 shows a view of an embodiment of a transition piece that includes turning vanes near the turbine inlet face; and

FIG. 10 shows a partial cut-away view of an embodiment of a monolithic transition piece that makes use of turning vanes.

### DETAILED DESCRIPTION

As discussed above, a hybrid gas turbine engine can make use of a pulse detonation combustor (PDC) or other pressure-rise combustor in combination with a turbine. While a variety of configurations are possible for such a hybrid gas turbine engine, many existing gas turbine engines that currently make use of constant pressure combustors are generally set up to use an axial turbine arrangement to extract power from the exhaust flow of the engine.

For example, the most common arrangement for gas turbine engines for use in jet airplanes produces a generally annular flow through the engine, and is designed with a shaft and other supporting structures located in the center of the annular flow path. In a hybrid gas turbine engine, such an axial flow arrangement may include a can-annular arrangement of PDCs in place of the traditional combustors, with the PDCs directing their flow into the purely annular flow passage of the turbine.

As used herein, a “pulse detonation combustor” or “PDC” is used to refer generally to any device or system that produces both a pressure rise and velocity increase from a series of repeating detonations or quasi-detonations within the device. A “quasi-detonation” is a supersonic turbulent combustion process that produces a pressure rise and velocity increase higher than the pressure rise and velocity increase produced by a deflagration wave. Embodiments of PDCs will generally include a means of igniting a fuel/oxidizer mixture, for example a fuel/air mixture, and a detonation chamber, in which pressure wave fronts initiated by the ignition process coalesce to produce a detonation wave. Each detonation or quasi-detonation is initiated either by external ignition, such as spark discharge or laser pulse, or by gas dynamic processes, such as shock focusing, auto ignition or by another detonation (i.e. cross-fire).

In the descriptions that follow, the term “axial” refers broadly to a direction parallel to the axis about which the rotating components rotate. This axis runs from the front of the system to the back of the engine. The term “radial” refers broadly to a direction that is perpendicular to the axis of rotation of the rotating components and that points towards or away from the axis. A “circumferential” direction at a given point is a direction that is normal to the local radial direction and normal to the axial direction as well.

An “upstream” direction refers to the direction from which the local flow is coming, while a “downstream” direction refers to the direction in which the local flow is traveling. In the most general sense, flow through the system tends to be from front to back, so the “upstream direction” will generally refer to a forward direction, while a “downstream direction” will refer to a rearward direction. In the specific examples given, the inlet is on the upstream, front side of the system, and the outlet is on the downstream, rear side of the system.

In addition to the axial and radial directions, the systems described herein may also be described with respect to a coordinate system of three perpendicularly oriented axes that will be referred to as the “longitudinal”, “lateral” and “transverse” directions. The longitudinal direction extends from front to back and is the same as the “axial” direction in all of the examples given herein. It will be understood that in other embodiments, the axes of rotation of various components may be oriented along other axes, but all examples described herein will use axes of rotation such that the longitudinal and axial directions are aligned. The lateral direction is defined as a direction normal to the axial direction that extends from one side of the system to the other. The transverse direction is normal to both the longitudinal and lateral directions and extends from the top of the system to the bottom.

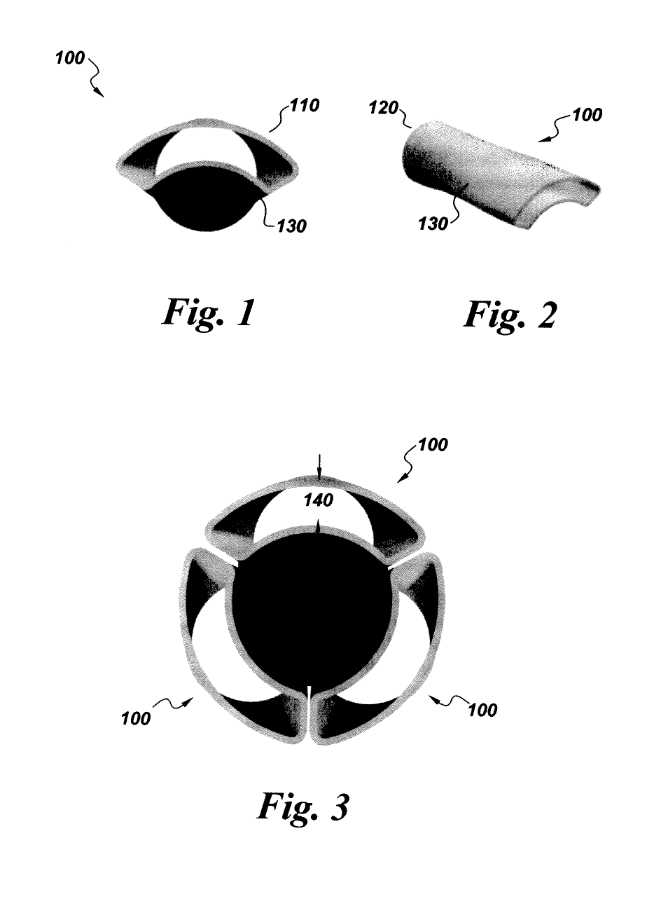

In order to make the outflow from each of the PDCs flow smoothly into the turbine stage of a hybrid gas turbine engine, a transition piece can be used to connect the exit of each PDC to a portion of the inlet to the turbine. This piece allows for a smooth transition in the flow from the PDC exit cross-section (usually circular) to an arc-segment of the annular turbine inlet (see FIGS. 1 and 2). An example of one such transition piece is shown in FIGS. 1 and 2, and discussed in greater detail below.

FIG. 1 shows an exemplary transition piece 100 that is configured to adapt the circular outflow from a PDC to an arc-segment suitable for a portion of the inlet flow to an axial turbine. The illustrated view is a rear view along the axis of the overall flow through the transition piece, i.e., a view from the turbine side looking upstream through the transition piece toward the combustor side. As can be seen, the transition piece 100 includes a turbine inlet face 110 that is shaped to provide the flow in a form suitable for input to an axial turbine. The transition piece also includes a combustor exhaust face 120 (see FIG. 2) that is shaped to receive the flow from a suitable PDC. A body 130 forms the surface of the transition piece 100 and connects the combustor face 120 of the transition piece to the turbine face 110. The body 130 provides a boundary to the flow and reshapes it along its path.

FIG. 2 shows another view of the exemplary transition piece 100 of FIG. 1. In this view, it can be seen that the overall structure of this exemplary transition piece provides for a reshaping of the exhaust flow from a PDC (not shown), while maintaining an essentially axial flow through the body 130 of the transition piece. Although the transition piece illustrated is shown for use with an essentially circular PDC exhaust and an arc-segment input to the turbine, it will be appreciated that there is no requirement for these particular shapes. The exhaust flow from the PDC may be configured in other shapes or patterns, such as rectangles, slots, ovals and such other forms that provide for beneficial operation of the PDC within the system.

Similarly, it should be understood that the precise form of the turbine inlet face 110 that is shown in the exemplary transition piece 100 of FIGS. 1 and 2 need not be the precise shape shown. In particular, it can be seen in FIG. 1 that the turbine inlet face 110 is configured for an approximately 120 degree arc-length of the overall circumference of the turbine. Such an arc-length is well suited for a system that makes use of three such transition pieces 100 to conduct the flow from three PDCs to a single circular axial flow turbine. Such an arrangement is shown in FIG. 3, where the arrangement of three transition pieces can be seen to provide for a nearly complete annulus of flow coming from the combination of the turbine inlet faces of the three transition pieces.

It will be well understood that arrangements of the turbine pieces that made use of a different arc-segment length could be used for hybrid engine configurations making use of a different number of PDCs. For instance, a system with 4 PDCs could be formed using 4 transition pieces with approximately 90 degrees of arc-length at the turbine inlet face of each. In addition to varying the arc-segment length of the turbine inlet face 110 of the transition piece, the radial height 140 may be configured to provide an appropriate match to the radial height of the vanes of the first stage turbine being driven by the exhaust from the PDCs.

In an embodiment where multiple transition pieces are used, each transition piece may connect a single PDC tube to a single arc-segment of the turbine inlet. For instance, if three PDC tubes are used in the combustor, then each transition piece will cover roughly one-third of the circumference of the turbine, at any radial station.

Desirably, the shape is changed gradually from the PDC exit shape to an annular arc-segment along the length of the transition piece. An arrangement of three transition pieces, suitable for use with a three PDC combustor system is illustrated in an axial view in FIG. 3. The particular arrangement of transition pieces 100 illustrated in FIG. 3 shows the combustor exhaust faces of the transition pieces disposed circumferentially around a central axis, and located relatively close to the axis. A central space is formed inside the inner surfaces of the bodies 130 of the transition pieces. While this arrangement schematically illustrates the essential arrangement, it will be appreciated that the central space may be made larger, or the combustor exhaust faces may be disposed further from the central axis by allowing for the transition piece to provide for radial repositioning of the flow in addition to reshaping of the flow. Such an arrangement that provides for an open area in the center of the transition pieces can accommodate a shaft or other mechanical connection between the turbine or any other rotating components of the hybrid engine.

In some embodiments of a transition piece suitable for conducting the flow between the exhaust of a combustor and a turbine inlet, the turbine inlet face can have still other shapes. For instance, in one embodiment, the turbine inlet face of the transition piece may be an entire annulus. Such a shape may be effective if a single PDC were used to direct flow into a turbine. In other embodiments, the turbine inlet face may be a partial segment of a cylinder. In yet another alternate embodiment, the turbine inlet face may comprise a shape that is not bounded by radial lines or which is not uniform at each circumferential position.

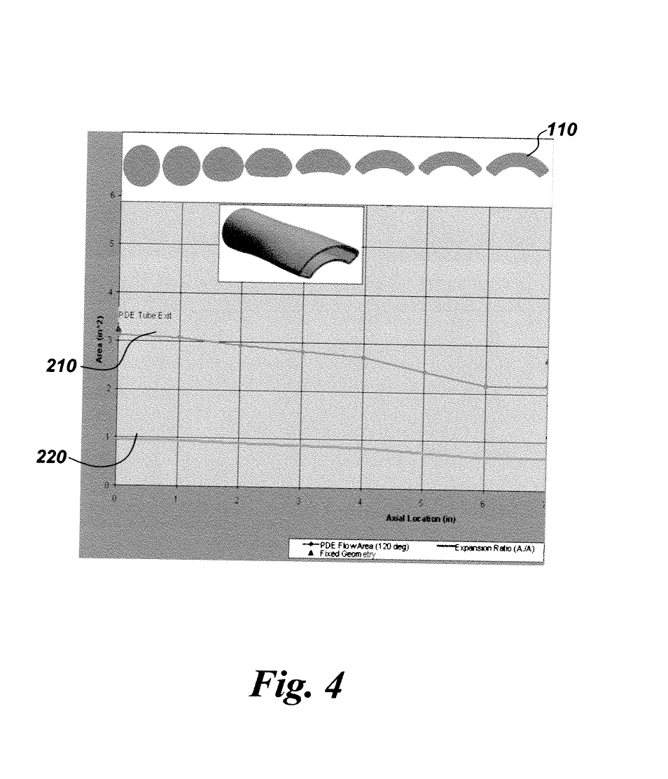

In one particular embodiment, a set of transition pieces suitable for rerouting the exhaust flow from a three-tube PDC combustor to a turbine inlet, as schematically shown in FIG. 3, was created. Each such transition piece has an inlet of nominal circular cross-section of 2.033 inch diameter, and an exit of a 120 degree arc-segment with a 1.7 inch inner diameter and a 2.4 inch outer diameter. The walls of the body are ⅛ inch thick. The cross-sectional area normal to the flow decreases from each upstream location to each downstream location, as discussed with respect to, and shown in, FIG. 4. Three pieces cover the entire circumferential extent of the inlet to a turbine.

This particular embodiment was tested during operation over the course of 7 minutes of firing the three PDCs at 10 Hz. Thermocouples were mounted both on the skin of the transition pieces and in the flow path. It was found that the temperature and pressure profile across the flow area of the transition piece was very uniform and showed less than a 20 degree variation in temperature as a result of the converging cross-sectional profile. The converging cross-sectional profile also minimized the strength of the reflected shock off of the downstream turbine face back into the transition pieces. It is generally desirable to inhibit the upstream propagation of this shock back into the PDC tube, as the shock can disrupt the fuel fill within the PDC and adversely effect the operation of the engine.

In particular, the schematic arrangement of FIG. 3 differs from a simple mixing plenum, which has been used in designs of PDC to turbine transitions in hybrid gas turbine engine systems to date. The use of multiple transition pieces can alleviate particular disadvantages of the mixing plenum that have been discovered during development of such hybrid engine designs. In addition to the tested arrangement, and that shown in FIG. 3, additional features and configurations are discussed below.

As mentioned above, the transition piece is intended to provide for a smooth flow transition between the shape and location of the combustor exhaust and the turbine inlet. To maintain the smoothness of the flow, it is generally desirable to prevent flow separation as the flow passes through the transition piece. To achieve this, it is desirable in some embodiments for the turbine inlet face (the exit of the transition piece) to have a smaller overall flow cross-section than the combustor exhaust face (the inlet to the transition piece). Such an arrangement, which is shown in the exemplary transition piece 100 shown in FIGS. 1 to 3, helps to maintain flow velocity and inhibit separation within the flow. In the illustrated embodiment, the flow area normal to the streamlines within the transition piece is smoothly decreasing, as will be discussed below with respect to FIG. 4.

As shown in FIG. 4, the cross-sectional shape 200 and area 210 of the interior flow path through the transition piece 100 may be varied along its length. The graph of FIG. 4 illustrates the variation of shape 200, area 210 and expansion ratio 220 of the flow through exemplary transition piece 100 along its length. Although transition piece 100 is shown with a particular length, area and profile, it will be appreciated that such specific dimensions are merely exemplary, and that operational transition pieces may have a variety of other sizes and areas without deviating from the concepts taught herein.

As can be seen at the top of the graph of FIG. 4, the cross-section shape 200 of the transition piece alters from a circular shape at the combustor exhaust face 120 to an arc-segment at turbine inlet face 110. It can also be seen by the graph of the cross-sectional area 210 that the size of the cross-section decreases along the length of the transition piece 100. The expansion ratio 220 of the flow is also graphed in FIG. 4. As can be seen by the graph, in the exemplary transition piece, the expansion ratio is always less than 1, and always decreases along the length of the transition piece.

To operate as efficiently as possible, it is desirable that there is relatively little pressure drop in the flow that passes through the transition piece. A pressure drop across the transition piece is a net loss of energy that will not be recovered by the turbine. This can be achieved by having a relatively smooth flow through the transition piece, and also by having the transition piece be as short in the axial direction as possible. However, the shorter the axial length of the transition piece, the greater the alteration in the flow shape and path must be per unit distance along the transition piece, and therefore the greater the turning that is induced in any given portion of the flow is likely to be. Greater turning in the flow can lead to greater likelihood of flow separation, which as mentioned above, is undesirable and can lead to a loss of flow efficiency and an increased pressure drop. However, by using a continuously converging (decreasing area ratio) transition piece, flow separation along the transition piece can be inhibited.

As shown in the transition piece 100 illustrated in FIGS. 1 to 4, individual transition pieces for each PDC can be used in one embodiment of a hybrid engine configuration. Each PDC will direct its exhaust into a separate transition piece, each of which will direct the flow into a portion of the annular inlet to a turbine of the gas turbine engine. This arrangement can provide an advantage in fabrication, and can also provide more flexibility for access to the engine, since each transition piece can be individually removed without removing all of them.

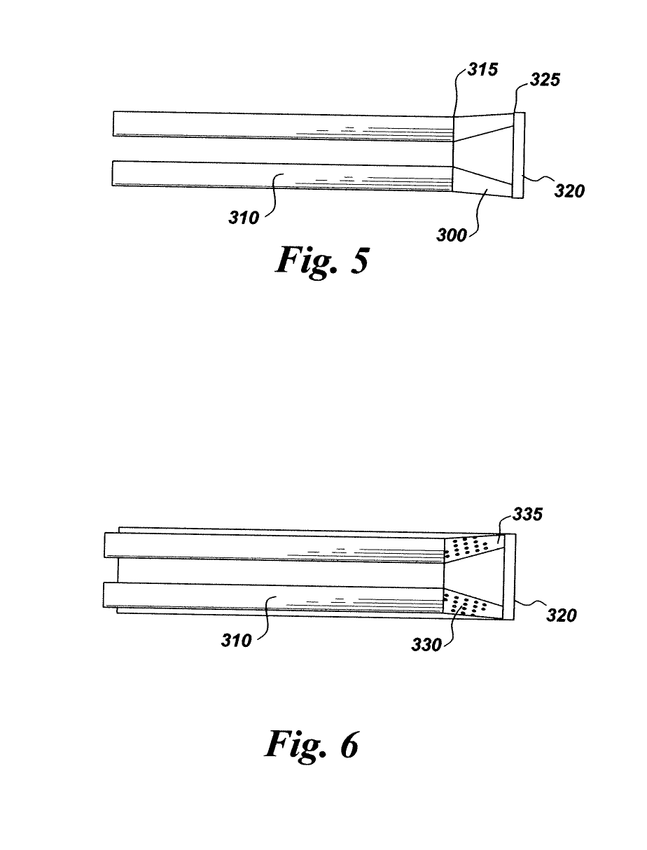

However, it will be understood that a single transition piece that connects the exhaust of multiple PDCs to a single turbine inlet face may also be used. Such an arrangement, schematically illustrated in FIG. 5, minimizes the number of walls between the arc-segments found in the arrangement of exemplary transition pieces 100 illustrated in FIG. 3. Eliminating such circumferential variations in the geometry can help reduce cold-streaks or other flow non-uniformities that can disrupt the flow into the turbine.

As can be seen in FIG. 5, a monolithic transition piece 300 is disposed between a can-annular bank of PDCs 310 and a turbine 320. In such an arrangement, the combustor exhaust face 315 of the transition piece 300 is disposed to receive the flow from multiple PDCs 310. Similarly, the turbine inlet face 325 of the transition piece 300 is configured to provide an annulus of flow to the turbine 320.

The flow through such a monolithic transition piece will necessarily have a different cross-section than that of a single transition piece 100 . However, the principles used to minimize flow separation and provide for efficient direction of the exhaust flow of the PDCs to the turbine is similar. In a particular embodiment, the cross-sectional area of the transition piece 300 will be continuously decreasing along its length in the downstream flow direction, as was the case for the transition piece 100 illustrated in FIG. 1.

Other embodiments of the transition pieces described herein may also include transition pieces that have perforated walls in their body. FIG. 6 illustrates a monolithic transition piece 330, similar to that shown in FIG. 5, that includes perforations 335 in the body of the transition piece. Such perforations allow for flow communication between the interior flow path of the transition piece 330 and the surrounding flow, such as the bypass flow 340. Such bypass flow may be part of the flow around the PDCs that is allowed to bleed into the transition piece. This bypass flow can provide a cooling effect to protect the material of the transition piece 330 that is exposed to the hot exhaust from the PDCs 310. Such bypass flow may also be used to help avoid separation or adverse pressure gradients in the flow through the transition piece 330, or enhance mixing within the transition piece in order to provide a more uniform flow to the turbine.

In another embodiment of a transition piece, shown in FIG. 7, the transition piece 400 is used to conduct the flow from multiple PDCs 410 at the combustor exhaust face 415 to the turbine 420, located downstream of the turbine inlet face 425. However, unlike the monolithic transition pieces 300, 330 illustrated in FIGS. 5 and 6, multiple transition pieces 400 are used around the circumference of the turbine 420. Such an arrangement may be used to gain some of the advantages of the monolithic transition pieces 300, 330 described above, while still retaining the ability to remove only one transition piece 400 if it becomes necessary to access the interior space of the hybrid engine. Such an arrangement may be especially useful if a large number of small diameter (relative to the engine diameter) PDCs are used.

In the embodiment illustrated in FIG. 7, the six PDCs 410 are themselves arranged in a can-annular arrangement, but the annular shape is not centered upon the axis of the hybrid gas turbine engine. Instead, the group of six PDCs are arranged into their own can-annular configuration, the exhaust of each PDC being conducted from the combustor exhaust face 415 of the transition piece 400 to the turbine inlet face 425 through a separate flow path 430 through the body 435 of the transition piece.

As discussed above, this embodiment provides a transition piece that provides for a multiple PDC to multiple outlet path through a single mechanical transition piece 400. By preserving this one-to-one ratio between the number of PDC tubes and the number of outputs to the turbine, the flow from each individual PDC can be controlled more effectively during the transition, and the difficulties associated with expanding the flow into a plenum (in this case formed by the joining of the separate flow paths from each PDC) upstream of the turbine inlet face can be avoided.

As shown in FIG. 7, the PDC exhausts from the illustrated annular group of PDCs 410 is conducted into a single arc-segment at the turbine inlet face 425 that spans about 90 degrees of the circumference of the illustrated turbine. Such an arrangement is appropriate when there are four groups of annularly arranged PDC tubes 410. In the illustrated embodiment, such an arrangement would have 24 PDC tubes arranged into 4 groups of 6 tubes. It will be understood that a variety of other numbers of groups, as well as different numbers of PDC tubes within each group, are possible, based upon other engineering considerations.

The embodiment illustrated in FIG. 7 shows a single can-annular arrangement of six individual PDCs 410 transitioning into a 90-degree arc-segment at the turbine inlet face 425. As discussed above, such an arrangements may allow for the use of multiple smaller PDCs in place of smaller numbers of larger tubes. Because PDC tube length tends to scale with the diameter of the tube in which the detonation is to be produced, using multiple smaller tubes can provide the same flow area with less run-up length, allowing for a more compact engine. Although illustrated as a complete annular arrangement of PDCs, it will be appreciated that other arrangements are possible in order to conform most appropriately to the available space and other engineering constraints. For instance, the PDCs could be arranged in one or more circumferential arcs in various embodiments.

In addition to reshaping the flow and repositioning the flow radially, a transition piece can also provide a change in circumferential position or velocity of the exhaust flow between the PDC exit and the turbine inlet. Such a change in circumferential position or circumferential velocity can be accomplished by offsetting the turbine inlet face circumferentially from the combustor exhaust face. In addition to allowing for the flow to be positioned effectively to accommodate internal design requirements, the addition of circumferential momentum to the flow entering the turbine can be used to help ease the transition between the exhaust flow and the flow into the turbine.

For example, by providing an appropriate degree of circumferential momentum to the flow entering the turbine, the need for a row of stators upstream of the first stage of rotors within the turbine assembly can be eliminated. This saves weight and reduces the complexity of the first turbine stage.

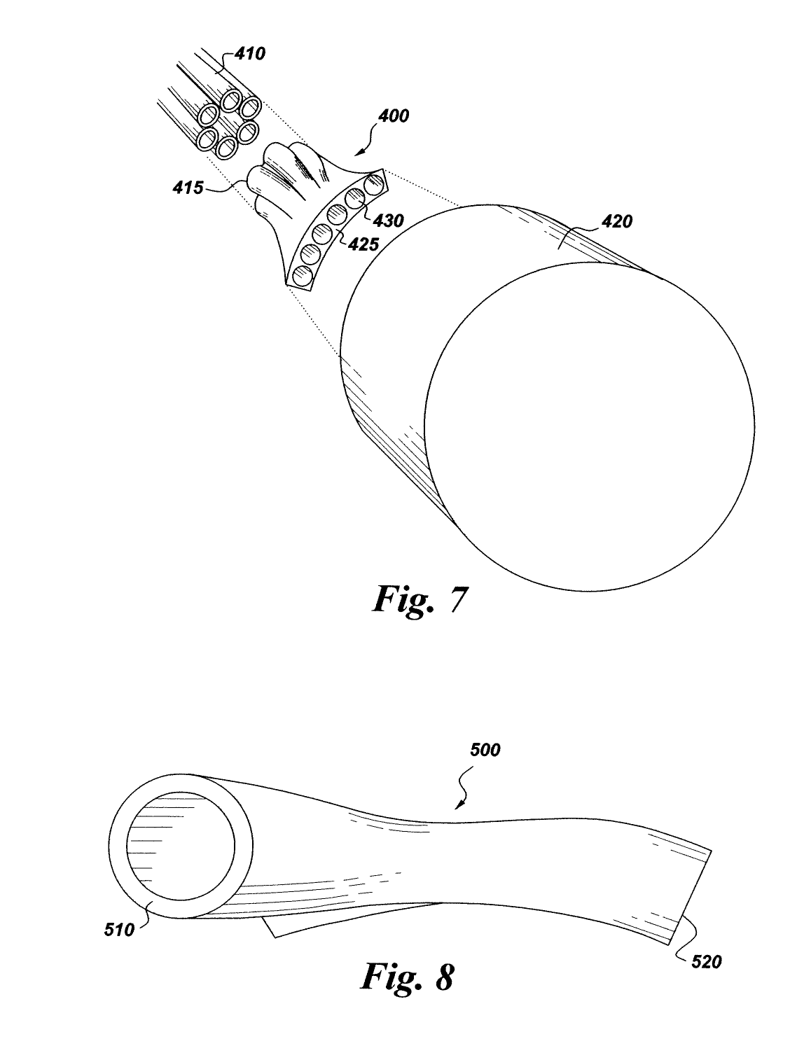

As mentioned above, circumferential momentum can be added to the flow by the circumferential displacement of turbine inlet face with respect to the combustor exhaust face. This results in the bulk flow through the transition piece requiring a net circumferential velocity in order to remain within the confines of the transition piece. An example of such a circumferentially displaced turbine inlet face on a transition piece can be found in FIG. 8. Transition piece 500 is shown in an axial view, looking downstream. As can be seen, the combustor exhaust face 510 is not centered upon the turbine inlet face 520. Because of this offset, the flow through transition piece 500 acquires a circumferential flow velocity as it passes through the transition piece.

Note that an arrangement making use of such circumferentially displaced faces may still have substantially the same cross-sectional profile as shown in FIG. 4. However, the position of each cross-section is circumferentially displaced by a successively greater amount along the length of the transition piece 500. This allows for a converging flow path to be used, even as circumferential momentum is imparted to the flow. In addition, because the cross-section at any station can be similar to that shown in the embodiment of FIGS. 1 to 4, multiple transition pieces 500 can still be used to surround a single central area.

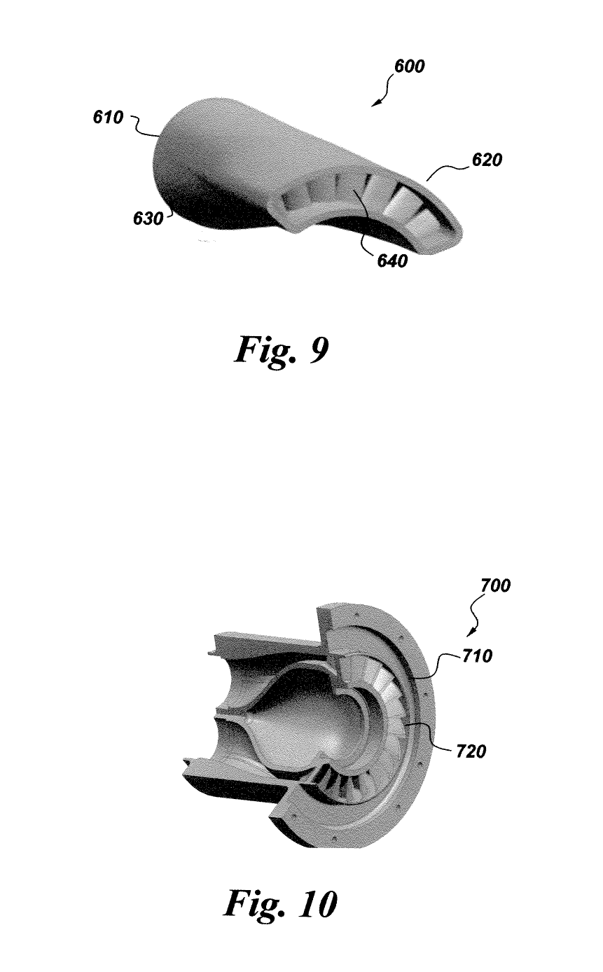

In addition to introducing such circumferential momentum by altering the circumferential position of the bulk flow of the fluid through the transition duct, as in the transition piece 500 shown in FIG. 8, the transition duct can also include turning vanes within the flow path through the transition piece that can assist in turning the flow. An example of such a transition duct is shown in FIG. 9 and discussed below.

FIG. 9 illustrates a transition piece 600 that, similar to that of FIG. 1, reshapes and converges the flow from a circular PDC exhaust at a combustor exhaust face 610 to an arc-segment forming the turbine inlet face 620 that is not circumferentially offset from the combustor exhaust face. Disposed within the body 630 of the transition piece 600 are a number of turning vanes 640 that impart circumferential momentum to the flow and alter its direction as it exits the transition piece. It will also be appreciated that the techniques of transition piece 500 from FIG. 8 and transition piece 600 from FIG. 9 can be combined.

The number and disposition of vanes may also be varied from that shown in FIG. 9. For instance, in one embodiment, a number of vanes may be located exclusively near the turbine inlet face, such that all turning of the flow that is performed by the vanes takes place near the end of the transition piece. In such an instance, multiple vanes near the turbine inlet face create a number of passages, or nozzles, between the vanes. These passages produce a flow direction that is at an angle to the axial direction.

In another embodiment, vanes may be located further upstream within the transition piece. In such arrangements, the vanes may produce circumferential momentum by creating flow at an angle to the axis upstream of the turbine face. The use of such vanes to create a row of nozzles inside the body of the transition piece may be combined with the use of vanes at the turbine inlet face.

Another embodiment makes use of vanes that extend significantly along the length of the transition piece within the flow path, effectively separating the transition piece into a plurality of nozzles along its entire length. When used with a transition piece that receives the exhaust from multiple PDCs, this arrangement can be used to create a one-to-one relationship between the PDCs and the output nozzles between the vanes. This can provide advantages such as those discussed with respect to FIG. 7 above.

Another combination that can be used when directing the exhaust from multiple PDCs to a turbine is shown in FIG. 10. Transition piece 700 is shown in partial cut-away view, and illustrates a monolithic transition piece that includes a turbine inlet face 710 that has turning vanes 720 disposed within it. This allows for the inclusion of circumferential velocity in the flow delivered from the transition piece, without requiring separate transition pieces (as in FIG. 3) or separate flow paths within a monolithic transition piece.

The various embodiments of transition pieces described above thus provide a way to guide and reshape the flow from PDCs to the inlet of a turbine in a gas turbine engine. These techniques and systems also allow for the flow to be turned so as to enter the turbine inlet at the appropriate angle.

Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, the use of turning vanes described with respect to one embodiment can be adapted for use with transition pieces that include perforations to introduce cooling air as described with respect to another. Similarly, the various features described, as well as other known equivalents for each feature, can be mixed and matched by one of ordinary skill in this art to construct additional systems and techniques in accordance with principles of this disclosure.

Although the systems herein have been disclosed in the context of certain preferred embodiments and examples, it will be understood by those skilled in the art that the systems may extend beyond the specifically disclosed embodiments to other alternative embodiments and/or uses of the systems and techniques herein and obvious modifications and equivalents thereof.

What is claimed is:

1. A transition piece for use within a gas turbine engine comprising:
an exhaust face in flow communication with an exhaust of a pulse detonation combustor of the gas turbine engine located upstream of the exhaust face;
a body in flow communication with the exhaust face and connected to the exhaust face and the body having a cross section taken normal to the axis of the gas turbine engine such that the area of the cross section at any given point along the axis of the gas turbine engine is smaller than the area of the cross section of the body at any point along the axis of the gas turbine engine upstream of the given point; and
a turbine inlet face in flow communication with a turbine stage of the gas turbine engine, the turbine stage being located downstream of the turbine inlet face, and the turbine inlet face being in flow communication with the body of the transition piece.

2. A transition piece as in claim 1 wherein the exhaust face has a circular cross section.

3. A transition piece as in claim 1 wherein the turbine inlet face has a cross-section in the shape of an annular arc-segment.

4. A transition piece as in claim 3 wherein the annular arc-segment is configured to extend over no more than one half of the circumference of an inlet to the turbine stage.

5. A set of transition pieces as in claim 4 comprising a plurality of transition pieces in flow communication with a plurality of pulse detonation combustors, the aggregate cross-section of the turbine inlet faces of the plurality of transition pieces spanning substantially the entire circumference of the inlet to the turbine stage.

6. A transition piece as in claim 1 wherein the flow out of the turbine inlet face has a net circumferential momentum.

7. A transition piece as in claim 6 wherein the flow through the transition piece at the turbine inlet face has greater net circumferential momentum than the flow through the transition piece at the exhaust face.

8. A transition piece as in claim 1 wherein the exhaust face is offset circumferentially from the turbine inlet face.

9. A transition piece as in claim 1 wherein the exhaust face is offset radially from the turbine inlet face.

10. A transition piece as in claim 1 further comprising a plurality of turning vanes disposed within the body of the transition piece, configured to provide a circumferential velocity to the flow through the turbine inlet face.

11. A transition piece as in claim 1 wherein the exhaust face is in flow communication with a plurality of pulse detonation combustors.

12. A transition piece as in claim 11 wherein the turbine inlet face of the transition piece has a cross section that covers the entire circumference of the turbine stage.

13. A transition piece as in claim 1 wherein the body of the transition piece comprises a plurality of perforations, each perforation providing flow communication between a bypass flow of the gas turbine engine and the flow through the transition piece.

14. A hybrid gas turbine engine comprising:
a plurality of pulse detonation combustors disposed around an axis of the gas turbine engine;
a transition piece disposed downstream of the pulse detonation combustors and in flow communication with at least one of the plurality of pulse detonation combustors;
a turbine disposed downstream of the transition piece and in flow communication with the transtition piece;
the transition piece comprising
an exhaust face in flow communication with the at least one pulse detonation combustor;
a body in flow communication with the exhaust face and connected to the exhaust face and the body having a cross section taken normal to the axis of the gas turbine engine such that the area of the cross section at any given point along the axis of the gas turbine engine is smaller than the area of the cross section of the body at any point along the axis of the gas turbine engine upstream of the given point; and
a turbine inlet face in flow communication with the turbine and the body of the transition piece.

15. A hybrid gas turbine engine as in claim 14 wherein the exhaust face has a circular cross section.

16. A hybrid gas turbine engine as in claim 14 wherein the turbine inlet face has a cross-section in the shape of an annular arc-segment.

17. A hybrid gas turbine engine as in claim 16 wherein the annular arc-segment is configured to extend over no more than one half of the circumference of an inlet to the turbine.

18. A hybrid gas turbine engine as in claim 17 further comprising at least one additional transition piece in flow communication with at least one of the plurality of pulse detonation combustors, the aggregate cross-section of the turbine inlet face of the transition piece and the turbine inlet face of the at least one additional transtition piece spanning substantially the entire circumference of the inlet to the turbine.

19. A hybrid gas turbine engine as in claim 14 wherein the exhaust face is offset circumferentially from the turbine inlet face.

20. A hybrid gas turbine engine as in claim 14 wherein the exhaust face is offset radially from the turbine inlet face.

21. A hybrid gas turbine engine as in claim 14 further comprising a plurality of turning vanes disposed within the body of the transition piece, configured to provide a circumferential velocity to the flow through the turbine inlet face.

22. A hybrid gas turbine engine as in claim 21 wherein the plurality of turning vanes form a plurality of nozzles at the turbine inlet face, and wherein the ratio of the number of the plurality of nozzles to the number of the plurality of pulse detonation combustors is 1.

23. A hybrid gas turbine engine as in claim 14 wherein the exhaust face is in flow communication with more than one of the plurality of pulse detonation combustors.

24. A hybrid gas turbine engine as in claim 23 wherein the turbine inlet face of the transition piece has a cross section that covers the entire circumference of the turbine stage.

25. A hybrid gas turbine engine as in claim 14 wherein the body of the transition piece comprises a plurality of perforations, each perforation providing flow communication between a bypass flow of the gas turbine engine and the flow through the transition piece.
